(19) United States
(12) Patent Application Publication
(10) Pub. No.: US 2015/0273779 A1
(43) Pub. Date: Oct. 1, 2015

(54) PRESS FOR MACHINING A WORKPIECE

(71) Applicants: Berthold DAUB, Netphen (DE); Daniel Hesse, Siegen (DE)

(72) Inventors: Berthold DAUB, Netphen (DE); Daniel Hesse, Siegen (DE)

(21) Appl. No.: 14/611,492

(22) Filed: Feb. 2, 2015

(30) Foreign Application Priority Data
Apr. 1, 2014 (EP) 14163064.0

(51) Int. Cl. B30B 15/02; B30B 15/28

(52) U.S. Cl. CPC B30B 15/026; B30B 15/28

(57) ABSTRACT

A press has a frame, an upper die vertically shiftable on the frame, a drive for vertically shifting the upper die on the frame, an upper holding ram vertically shiftable in the upper die, and an upper actuator connected between the upper holding ram and the upper die and operable to move the upper ram vertically relative to the upper die. There is also a lower die on the frame below the upper die, a lower holding ram vertically shiftable in the lower die, a lower actuator connected between the lower holding ram and the lower die and operable to move the lower ram vertically relative to the lower die. A bridge unit is connected between one of the actuators and the respective die for bridging an acceleration phase of the respective actuator in which the respective actuator can be accelerated to the speed of the respective ram.

### FIELD OF THE INVENTION

The present invention relates to a press. More particularly this invention concerns toggle-linkage press for machining a workpiece.

### BACKGROUND OF THE INVENTION

A toggle-linkage press for machining a workpiece has a normally fixed lower die subassembly and a normally vertically movable upper die subassembly. The upper die subassembly has a hold-down device with a ram for holding down the workpiece to be machined on the lower die subassembly, and the lower die subassembly has a holding device with another ram that pushes the workpiece up against a die of the upper die subassembly. The two rams are each displaceable with respect to the respective upper and/or lower die subassembly by a respective actuator.

Generic presses are known from the prior art. In some forming operations, such as precision cutting for example, a hold-down device and a holding device are needed to machine the workpiece accurately. As a rule, the hold down is a ram in an upper die subassembly and bears on the material of the workpiece to be machined in order to counteract the compressive and tensile forces that occur in the machining operation. As a rule, the holding device is a holding ram directly beneath the material to be formed. During the entire forming operation, it holds with the most constant possible force against a cutting punch coming from above in order to ensure a controlled forming operation. Following the forming operation, the holding device and/or the additional (in this regard) ram may function as ejectors for the cut part. The press pad and the bracing device may be mechanical (for example, mechanical spring elements), pneumatically or hydraulically (for example, pneumatic or hydraulic spring elements).

### OBJECTS OF THE INVENTION

It is therefore an object of the present invention to provide an improved press for working a workpiece.

Another object is the provision of such an improved press for working a workpiece that overcomes the above-given disadvantages, in particular that so that their manufacturing precision and reliability are further increased.

### SUMMARY OF THE INVENTION

A press has according to the invention a frame, an upper die vertically shiftable on the frame, a drive for vertically shifting the upper die on the frame, an upper holding ram vertically shiftable in the upper die, and an upper actuator connected between the upper holding ram and the upper die and operable to move the upper ram vertically relative to the upper die. There is also a lower die on the frame below the upper die, a lower holding ram vertically shiftable in the lower die, a lower actuator connected between the lower holding ram and the lower die and operable to move the lower ram vertically relative to the lower die. A bridge unit is connected between one of the actuators and the respective die for bridging an acceleration phase of the respective actuator in which the respective actuator can be accelerated to the speed of the respective ram.

It is possible through such bridging unit or means to accelerate the respective ram immediately at the start of a cutting operation or the like, while bypassing its actual actuator, for example, to the speed of the ram corresponding thereto.

According to the invention, a bracing device of the lower die subassembly in the present case for example, may be moved from the beginning in precise synchronization with the movement of the upper die subassembly and/or a cutting punch or the like in this regard. It is possible to significantly increase the manufacturing precision in this way.

A response time with a sufficiently large time window is available for the actual actuator to also accelerate the respective actuator to the respective ram speed before the actuator then drives the bracing device.

Due to the fact that the bridging means are integrated into the holding device and/or, cumulatively or alternatively, into the hold-down device, the respective ram may be accelerated independently of its actual actuator by the respective corresponding ram in a very simple construction.

With the present bridging means, the essential goal of providing, on the whole, a drive by means of which there may be pinpoint synchronization of the movement of the bracing device in particular with a ram speed of the upper die subassembly at the start of a cutting operation.

For example, after a successful cutting operation, the respective ram, whose speed has been synchronized according to the invention, may assume an ejector function, for example, which is preferably freely programmable with respect to its path.

The term “press” in the sense of the present invention describes any type of press in which the upper die subassembly is moved with respect to the lower die subassembly or vice versa, to thereby machine the workpiece with at least one die. It is self-evident that this press may be designed in almost any way. It is particularly advantageous if the press is embodied as a toggle-linkage press and specifically as a precision cutting and forming press having a servo toggle-linkage actuator because this is often used in many high-precision machining operations. Additional advantages are explained in detail below in conjunction with a press designed as a precision cutting and forming press having a servo toggle-linkage actuator, for example.

The term “upper die subassembly” in the present case describes a press ram of a press, which is moved with respect to a press bed for machining the workpiece.

Accordingly, the term “lower die subassembly” in the present case describes a press bed of a press in this regard.

The die and/or die part used on the present press may be of various types. For example, it may be a cutting die, as will be explained in greater detail below.

The ram of the hold-down device has a press pad. The holding ram of the holding device has a bracing device accordingly.

In contrast with the holding device, the movement of the hold-down device is not stopped by passing through the lower dead center of the upper die subassembly. During the upward movement of the upper die subassembly, the hold-down device functions as a stripper over a defined path. During the stripping, the movement of the hold-down device must still take place synchronously with the movement of the ram.

For operation of the hold-down device and/or holding devices, two modes of operation are provided in principle: set up and automatic. In addition to manual typing, the operator may automatically enter a preset ideal position or a coupling position that fits the press position. The hold-down device and/or holding device may be moved independently of one another but never at the same time. The choice of the active device is made by buttons using a display. It is also possible after input of the ideal values to create a corresponding movement profile for the devices. Specifically for the holding device, the desired function “hold up−eject (=1)” or “only eject (=2)” may be input as function numbers by an input field. In automatic operation, the selected device is activated and coupled to the movement of the upper die subassembly by a cam disk. The values set during setup operation are valid. Multiple devices may also be selected and activated together here.

At any rate, the period of time needed to accelerate the respective actuator to the speed of the ram in a suitable manner can be bridged advantageously by the present bridging means in order to drive the ram assigned to it with a time offset.

It is self-evident that the bridging means provided in the sense of the invention may be of various designs. However, a preferred embodiment is that the bridging means comprise a pneumatic spring. Such a pneumatic spring may be designed with a simple structure in the lower die subassembly and/or the upper die subassembly.

The present pneumatic spring is implemented with a particularly expedient construction when the pneumatic spring comprises a nitrogen spring.

It is particularly advantageous if the bridging means comprise a reaction stroke of more than 10 mm or more than 20 mm, preferably 25 mm. By means of such a reaction stroke, it is possible to ensure that the respective actuator can be accelerated to the speed of the ram assigned to it during the machining operation.

Furthermore, the present reaction spring displacement of 25 mm can be provided easily with a simple design by the nitrogen spring.

In this respect, the integration of the pneumatic spring within a hold-down device and/or a holding device on presses is already advantageous per se. For this reason alone, the features with respect to this pneumatic spring are also advantageous, even without the other features of the invention.

Depending on the type of use, a smaller reaction stroke of 10 mm or 20 mm may be sufficient to create the required bridging time period. Such a required bridging time period may be made available in any case in a reliable manner if the reaction stroke is 25 mm.

It is self-evident that the reaction stroke may also be selected to be larger. However, this is not advisable because a sufficient response time can be made available through a reaction stroke of 25 mm. Furthermore, larger reaction spring displacements merely require an unnecessarily large design space.

Such a reaction stroke is formulated in a structurally simple manner in the present case if the reaction stroke is formed between a piston bottom of the piston and the cylinder end wall of the cylinder by a pressure chamber filled with a pressure medium. The pressure medium may be of various types, but preferably comprises nitrogen.

The bridging means may be integrated structurally into the upper die subassembly and/or the lower die subassembly of the present press in a particularly advantageous manner if the bridging means are arranged between the ram and the actuator.

In addition, it is advantageous if the bridging means have a cylinder and a piston, with the ram being arranged on the cylinder. Components of the bridging means may be integrated compactly into the press in this way. This can be achieved structurally with the pneumatic spring.

A region of the lower die subassembly facing the upper die subassembly may be overcome in a structurally simple manner by bridging means arranged within the lower die subassembly if the ram is arranged on the cylinder a spacing away from the end wall of the cylinder.

The bridging means can respond easily and quickly structurally if the bridging means have a cylinder and a piston guided in the former, wherein the cylinder is arranged in the lower die subassembly, so that it can be displaced in the press direction of the upper die subassembly.

If the bridging means have a cylinder and a piston guided therein, wherein the cylinder is displaceably guided in a guide bushing of the upper die subassembly or the lower die subassembly, then the cylinder may be moved with respect to the upper die subassembly or the lower die subassembly, on the one hand, and with respect to the piston, on the other hand.

In addition, it is advantageous if the bridging means have a cylinder and a piston guided therein, wherein the cylinder is displaceable by the piston with respect to the upper die subassembly or the lower die subassembly. The cylinder can be displaced over the piston in a structurally simple manner by the actuator in this way. This is the case, for example, when the holding ram of the holding device is to be moved synchronously with the upper die subassembly or when the holding ram of the holding device is to function as an ejector for a machined workpiece.

The respective ram can be displaced with no problem with respect to the upper die subassembly or the lower die subassembly if the bridging means have a cylinder and a piston guided therein, wherein the piston is arranged on a connecting rod of an eccentric drive of the actuator.

A sufficient counterforce can be applied to the holding ram of the lower die subassembly in particular when the pneumatic spring is prestressed with a spring force F with a value of more than 100 kN or with a value of more than 200 kN, preferably with a value of 300 kN.

An essential core point of the present invention is in particular synchronization of the holding ram and/or the bracing device to the speed of the ram and/or the upper die subassembly at a point in time which approximately represents the start of a cutting operation or the like. By means of the present bridging means, it is possible to ensure that the holding ram and/or the holding device will at least move approximately at the same speed as the ram and/or the upper die subassembly as of this point in time.

According to another aspect of the invention, the present object is also achieved by a press, in particular a toggle-linkage press, for machining a workpiece with a lower die subassembly, with an upper die subassembly movable relative to the former, and with an overload protection unit for protecting the press in the event of a malfunction, in which the upper die subassembly has a hold-down device with a ram that can hold down the workpiece to be machined with respect to the lower die subassembly, and the lower die subassembly has a holding device having a holding ram that can hold up the workpiece to be machined against a die of the upper die subassembly. The rams are each displaceable by an actuator with respect to the upper die subassembly and/or the lower die subassembly, and the press is characterized in that the holding device and/or the hold-down device comprise(s) bridging means for bridging a deployment time for deploying the overload protection unit.

Despite a plurality of safety precautions, such as providing an overload protection unit, irreparable or at least very cost-intensive damage often occurs to the presses due to malfunctions. Since these bridging means are integrated into the holding device and/or, cumulatively or alternatively, in the hold-down device, the risk of serious damage to the press in a malfunction can be reduced significantly. In this respect, this risk can also be reduced significantly with the help of the bridging means already described in detail above.

A malfunction in this regard may occur because of any defect in the press. For example, if a workpiece is not properly removed from a previous cycle and is still in the die of the lower die subassembly, or if the holding device does not yield because of a malfunction of its actuator.

The overload protection unit may be of a wide variety of designs. It is preferably designed so that the drives of the holding device and/or of the hold-down device are switched to no torque (safe torque off) in particular in the event of a fault, so that an actuator, which is designed essentially as a slider crank drive, may be forced into its lower stretch position, so that no critical hold-down forces and/or hold-up forces are created on the respective ram.

Deployment of the actual overload protection unit may be performed in an operationally secure manner if the press includes a control and/or regulating device, by means of which the overload protection unit can be deployed as a function of the bridging means. The overload protection unit can respond rapidly and promptly by such a control and/or regulating device.

A first independent overload protection element may also be made available by the pneumatic spring already mentioned above, This element prevents a mechanical overload of function components on the press, even if there is no deployment of the actual overload protection unit of the press. In the present case, the reaction stroke also makes an overload spring path available at the same time.

In this respect, integration of the pneumatic spring within a hold-down device and/or a holding device on presses is already advantageous per se, as already described further above. For this reason alone, the features with respect to this pneumatic spring are advantageous even without the other features of the invention.

In particular due to an arrangement of the bridging means, the ram and the actuator, the first independent overload protection element may be arranged close to a location at which overload forces can be accommodated at least partially and compensated in a simple design. This applies in particular to the pneumatic spring.

By means of the present invention it is advantageously possible in particular to further develop the precision cutting and forming presses mentioned above with a servo toggle-linkage actuator.

These precision cutting and forming presses fulfill in particular rising quality demands and/or rising demands for minimal tolerances and specifically the stipulations of suppliers in the automotive field. Components with a higher smooth cut surface can be manufactured in particular with these precision cutting and forming presses in the automotive field. The present press is thus advantageous in particular for users in the quality field of normal cutting and precision cutting because these users can significantly expand their range production and can produce parts with an improved cut quality.

Specifically with a precision cutting and forming press having a servo toggle-linkage actuator, the production costs can be lowered by manufacturing high-precision parts in subsequent composite or transfer dies. Furthermore, a minimal need for reworking eliminates complex process steps and also lowers handling costs accordingly.

In addition, the precision cutting and forming presses having servo toggle-linkage actuators also offer even greater system robustness, so that narrow component tolerances and reliable repeat accuracy are made possible with different material thicknesses and strengths. In addition to optimized design of the forming operation through progressive composite dies or transfer dies, additional upstream or downstream process steps may be included. Thus, the precision cutting and forming presses having a servo toggle-linkage actuator in particular allow cutting, drawing, embossing, perforating and/or calibrating during a press run.

Furthermore, the upstream or downstream processes, for example, thread forming, joining or welding can be integrated in the present case. Thanks to the servo technology, the course of the ram can be adapted optimally to a forming and/or cutting operation. In addition, through the use of retrofittable hold-down modules and bracing modules, manufacturing of cut parts with a greater smooth cut surface may be made possible. For the customer, this means an increase in flexibility, output and lifetime of the dies.

For example, manufacturing methods according to DIN 8580 are subdivided into six main groups, namely primary forming, re-forming, separating, joining, coating and changing physical properties. Separation is fabrication by changing the shape of a solid body, so that the cohesion is completely eliminated locally. The final form is contained in the starting form. Breaking down assembled bodies is also classified as separation. The main group of separation is in turn further subdivided into dissecting, machining and abrading. Cutting or shearing cutting belongs to the subgroup of dissecting. Within the context of this work, precision cutting describes the manufacture of cut parts with a cut quality that can be classified between shearing cutting and precision cutting. A further subdivision can be made on the basis of the cutting method, depending on the cut face relative to the workpiece border. A distinction is made between cutting out, perforating, cutting off, notching, scoring and clipping. The two methods of cutting out and perforating are of interest for precision cutting. The special feature of cutting out and perforating is that these methods have a self-contained cutting line. The workpiece part forced through the cutting plate by a ram forms the workpiece in cutting it out, and the remainder of the sheet metal is removed as waste, but in perforating, the part that is cut out is waste. An internal contour is created.

A cutting die consists essentially of a shearing punch, a die plate or cutting die and a press pad. The press pad prevents sagging and excessive free flow of the material. The material of the workpiece to be cut in the form of a circuit board, a sheet or a strip between the cutting punch and the die plate may be shifted and separated by downward movement of the cutting punch. To prevent jamming of press waste thereby created, the passage through the die plate is not usually cylindrical but instead is provided with a clearance angle. The actual die design depends on the requirements of the cut workpiece.

Shear cutting may be subdivided into five phases. During the first phase, the press pad is first placed on the sheet metal and a hold-down force F_{NH} is built up. In the second phase, the cutting punch is placed on the sheet metal, resulting in elastic deformation of the press and the die. Because of the cutting clearance, a bending moment, which results in bending deformation, occurs in the sheet metal. A ring zone develops in the region of the cutting clearance. This is the contact area between the surface of the sheet metal and the cutting element. The third phase is the actual cutting phase, when the punch penetrates into the sheet metal, which thus undergoes plastic deformation. The flow capacity of the material is exhausted in the fourth phase. When a cleavage fracture occurs, the remaining cross section of the sheet metal breaks away. Due to the sudden severance, the press, and in particular also the upper die subassembly and/or the press ram is/are excited to vibration. In the fifth and final phase, the cutting punch forces the cut waste into the die plate duct to reach the lower dead center of the upper die subassembly. The height of the shearing zone and that of the smooth cut surface are usually evaluated as a proportion of the sheet metal thickness s. Sheet metal plates of various thicknesses can be compared on the basis of these amounts. A high-quality cut part is characterized by a low edge contraction, a small shearing zone proportion and minimal burr with a large smooth cut portion and a shearing zone angle of 90°. The quality of the cut image is determined mainly by the cutting clearance u, in addition to the material used, the material thickness and the wear condition of the cutting elements. If the cutting clearance is too small, cracks will occur already in initial cutting of the sheet metal. The reason for this is relatively high transverse stresses. Straight cut surfaces are not formed on the workpiece but instead only incipient cracks are formed. If the cutting clearance u is too large, cracks are formed immediately after the force peak. The possible cutting clearance is given as u=0.02×plate thickness s, up to u=0.1×plate thickness s. The lifetime of the dies also depends on the cutting clearance. The ratio of smooth cut surface to fractured cut surface amounts to approximately one-third to two-thirds for a shear-cut part. Because of the special function requirements, the cut surfaces of such parts must be reworked. Forces act in and on the plate in shearing cutting. The vertical force components F_{V} and F_{V}′ as well as the horizontal force components F_{H} and F_{H}′ act on the cutting clearance. These form a dynamic equilibrium with the resulting friction forces. The distance between the points of attack of the force components causes the formation of a torque, which leads to bulging of the plate under the punch and over the female die in the case of a closed cutting line. The required counter torque can be applied by a counter punch to compensate for the bulging. Without the hold-down force, the plate would also bulge above the die plate. To eliminate the reworking effort (time, expense) of a part produced by conventional shearing cutting, methods have been developed to improve the quality of the cut surfaces. In rebutting, the smooth cut surface component is increased in two process steps because of better stress ratios in the material. In the first step, the part is precut with a small oversize allowance in order to separate this rebutting allowance by an additional shearing cut in the second step. Counter cutting is also a two-step operation. A special feature of this process is the double presence of the active die elements. In the first step, the plate is notched from one side up to just before the occurrence of a break. In the second step, the workpiece is separated from the other side by the second die. This method yields absence of burrs and an improved smooth cut surface. As the last modified shearing cutting method, normal cutting with a small cutting clearance u<0.05×plate thickness s should be mentioned. However, there have not yet been any systematic studies of this method (for example, the service life of the dies). Like conventional shearing cutting, precision cutting according to DIN 8580 belongs to the main group of separation, namely the subgroup of dissecting. In contrast with shearing cutting or shearing cutting with a smooth dissection surface, process parameters that have been altered in precision cutting occur, leading to improved quality features of the cut part. The die structure, the active forces, the knife-edged ring and the cutting clearance are characteristic of this method. The knife-edged ring is forced into the plate when the hold-down device is placed on it. Furthermore, a counter punch presses against the plate from beneath. The resulting compressive stresses influence the separation operation in such a way that the smooth cut surface component extends over the total thickness of the plate. After the cutting operation, the hold-down device acts as a stripper. The counter punch acts as an ejector, which pushes the part upward out of the die plate, where the cutout is removed. The forces for the knife-edged ring and the holding device are generated hydraulically. The cutting force is generated mechanically in the case of machines up to approx. 1600 kN (≈160 t) or hydraulically in the case of larger machines of 2500 kN to 14,000 kN. The altered process parameters yield a different cutting force curve in precision cutting in contrast with shearing cutting. The elastic phase and the cutting phase are identical, but there is no break-away phase or vibration phase and there is also no cutting impact. As mentioned previously, the quality of the cut surface is determined by the cutting clearance. In normal shearing cutting, the cutting clearance is between 5% and 10%, but in precision cutting, this amounts to approx. 0.5% of the plate thickness s to be cut.

Regardless of their embodiments, the hold-down device and/or holding device ideally fulfill the following boundary conditions:

The hold-down device and/or holding device can be moved as a function of the movement of the upper die subassembly.

The hold-down device and/or holding device may be programmable independently of one another.

The hold-down device and/or holding device may be furnished with a press force measurement for process monitoring.

The hold-down device and/or holding device may contain a mechanical overload protection unit to prevent or reduce damage.

There must be enough time and distance for acceleration.

After the forming is concluded, the bracing device of the holding device should function as an ejector.

The operator must have the option of adapting the hold-down device and/or holding device to the forming operation by a simple operating concept and to readjust the bracing force or hold-down force, if necessary.

### BRIEF DESCRIPTION OF THE DRAWING

The above and other objects, features, and advantages will become more readily apparent from the following description, reference being made to the accompanying drawing in which:

FIG. 1 is a schematic view of a precision cutting and forming press having a servo toggle-linkage actuator with bridging means for bridging a deployment time for deployment of an overload protection unit and having a control and/or regulating device for same;

FIG. 2A is a schematic view of a starting position of an actuator with a pneumatic spring of the holding device of the precision cutting and forming press from FIG. 1;

FIG. 2B is a schematic view of a second position of the actuator with a compressed pneumatic spring of the holding device of the precision cutting and forming press from FIG. 1;

FIG. 2C is a schematic view of a third position of the actuator with the holding device moved synchronously with an upper die subassembly of the precision cutting and forming press from FIG. 1;

FIG. 2D is a schematic view of a fourth position of the actuator with the holding device moved into a lower reversing position of the precision cutting and forming press from FIG. 1;

FIG. 3 is a schematic view of a slider crank drive to illustrate an example of the function of an actuator of a hold-down device and/or holding device of the precision cutting and forming press from FIGS. 1 and 2;

FIG. 4 is a diagram showing ejector kinematics with respect to the holding device from FIGS. 1 through 3;

FIG. 5 is a schematic view of a function sequence during a machining operation on the precision cutting and forming pressure of FIG. 1; and

FIG. 6 is a diagram showing the characteristic line of a bracing ejector function in conjunction with a that of a cutting punch.

### SPECIFIC DESCRIPTION OF THE INVENTION

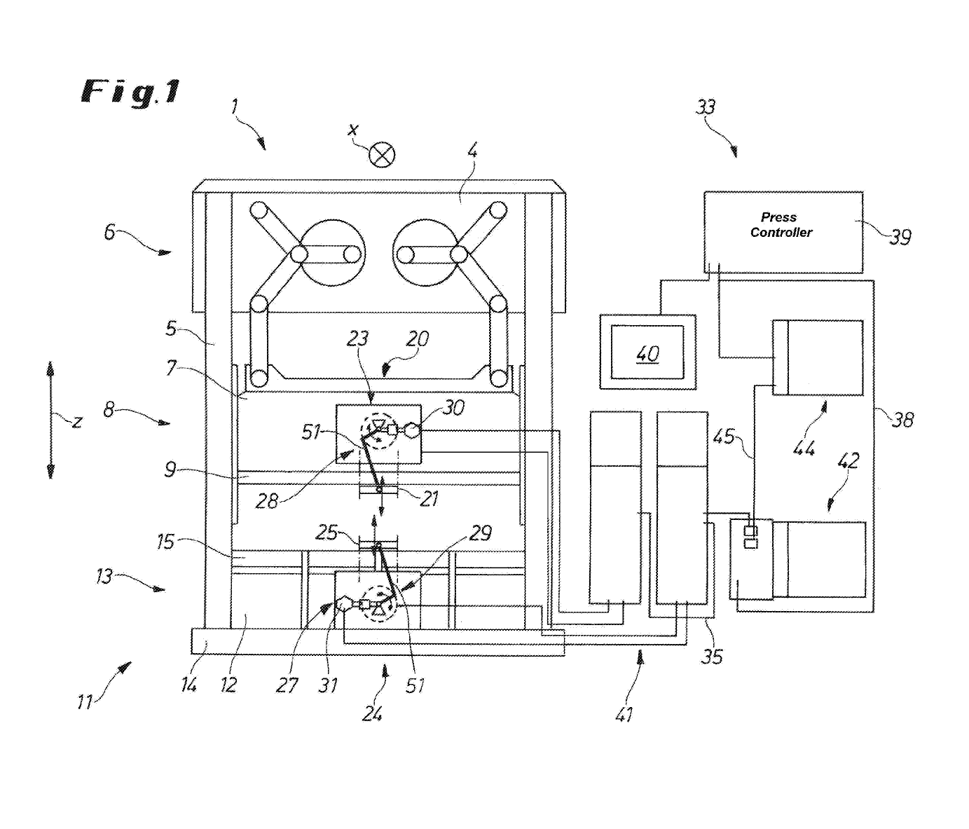

As seen in FIG. 1 a press 1, shown as an example in FIG. 1, is a toggle-linkage press and specifically a precision cutting and forming press, having a servo toggle-linkage actuator 4. Such a servo toggle-linkage actuator 4 is known from the prior art, so its components and functioning will not be described further here.

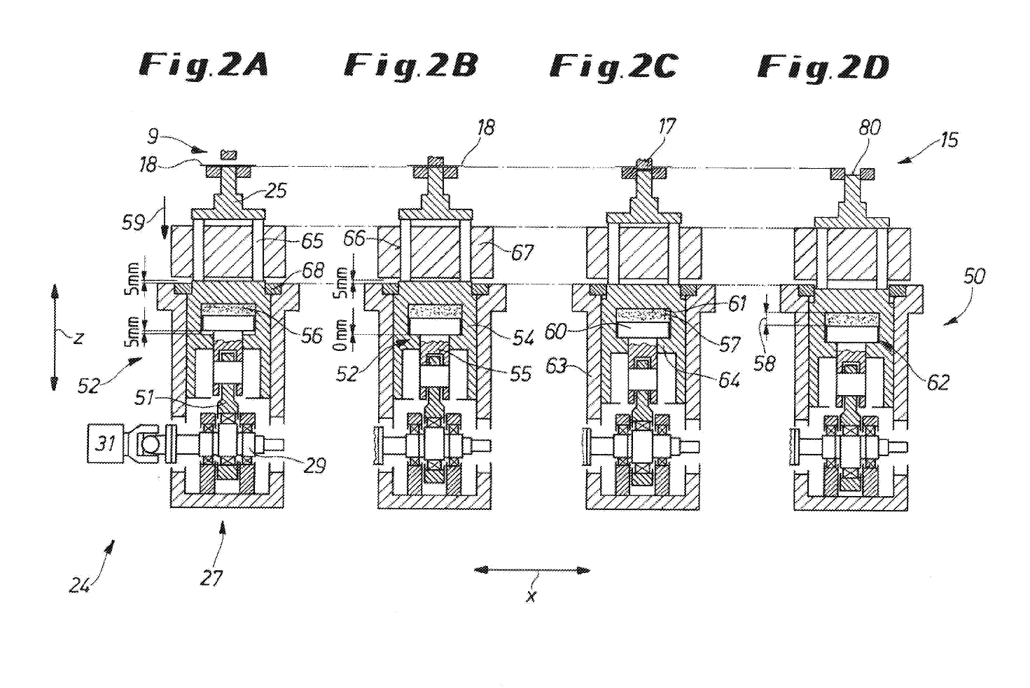

The press 1 has a welded press frame 5 having an upper region 6 on which the servo toggle-linkage actuator 4 is mounted. Below the actuator 4 is an upper die subassembly 8 with a press platen 7 displaceable in a vertical direction z (press direction and/or ejector direction) on the press frame 5. The upper die subassembly 8 also carries an upper die or cutting punch 9 (see FIGS. 2A through 2C). A lower platen 12 in a lower region 11 of the press frame 5 forms part of a lower die subassembly 13, The press frame 5 and lower platen 12 are secured on a base 14. The lower die subassembly 13 carries a lower die 15 here formed as a plate (see FIGS. 2A through 2D), by means of which the cutting punch 9 can punch out waste 17 (see FIG. 2C) from a sheet-metal workpiece 18 that is conveyed in steps in a horizontal travel direction x. To do so, the upper die subassembly 8 is moved downward in the vertical direction z toward the lower die subassembly 13. After punching, the upper die subassembly 8 is moved upward back in the direction z away from the lower die subassembly 13.

The press 1 in this embodiment also has an unillustrated overload protection unit that operates when a malfunction occurs during a machining operation in order to prevent damage by the press 1. To be able to hold down the workpiece 18 during a machining operation with respect to the lower die subassembly 13, the upper die subassembly 8 has a hold-down device 20. This hold-down device 20 has a hold-down ram 21 displaceable here with respect to the upper die subassembly 8 by an actuator 23 in the direction z.

In order to be able to hold the workpiece 18 against the actual press direction during the machining operation from beneath, the lower die subassembly 13 is also equipped with a holding device 24 that carries has an additional holding ram 25. The holding ram 25 here is displaceable with respect to the lower die subassembly 13 by an additional actuator 27 also in the direction z. The two actuators 23 and 27 operate independently of each other and are essentially the same except for their respective rams 21 and/or 25 and, in this illustrated embodiment, each has an eccentric drive 28 or 29 driven by a respective motor 30 or 31.

The press 1 is controlled with or without feedback by a controller 33. Converters (not shown) are connected here to a CX (not shown) by EtherCAT connections 35. Data is exchanged with a press controller 39 and a display 40 over a PROFIBUS 38. In addition, rotation sensors 41 inside the motor for regulating the actuators 23 and 27 plus additional rotation sensors 42 for determining the position of the hold-down and holding devices 20 and 24 are connected directly to the converters. To be able to process an actual or simulated press angle in the CX, an axial control 44 of the press 1 and the control and/or rotation sensor 42 of the actuators 23 and 27 are connected by a real-time Ethernet (RT Ethernet) 45. Due to the Ethernet terminals of the CX, which can be configured independently of one another, one of the two terminals for connecting the CX to a machine/company network may be used. The other terminal may be addressed independently thereof and thus serves as a plain RT Ethernet connection 45. The bracing and hold-down forces are determined by piezo sensors. In order not to introduce another new system, the same sensors and evaluation units as those also used for measuring the pressing force of the press are used here. The output signal of the piezo sensors is amplified in a charge amplifier and scaled to an analog output voltage of 0 V to 10 V, where 0 V corresponds to F=0 kN; 8 V corresponding here to F=300 kN. The “missing” 2 V serves as a reserve for detecting an overload. The output signal of the charge amplifier is input via the analog input card and processed further. The hold-down device and the holding device 20 and 24 are moved in a position-regulated manner and partially synchronously with the upper die subassembly 8. The control PC used for this purpose is connected directly to the press controller 39 by a real-time Ethernet connection so that synchronous movement to the upper die subassembly 8 can be assured at any time, regardless of which curve is currently being followed by the press 1.

The movements of the hold-down device and holding device 20 and 24 are preferably implemented by an electronic cam. This cam is created individually as a function of the process and the selected press curve. The operator inputs interpolation points for calculation of this curve via an input mask. The trajectory for the optimal guidance of movement is created automatically by interpolation within the controller. If the press 1 has reached lower dead center, the holding devices 20 and 24 remain there in the locked position. The ejection movement begins on reaching a predefined press angle. The control is programmed so that a synchronous movement beyond the lower dead center of the upper die subassembly 8 would also be possible. The motor-converter configuration that is used here is regenerative. Energy released by the motor is preferably fed back into the intermediate circuit of the converter. When it is fully charged, the excess energy is fed back into the access network. For the case when the upper die subassembly 8 is to operate only as a “traditional” ejector, this may be selected by the operating mask. Three possibilities are available:
1. Bracing (synchronously with the upper unit 8) until reaching the lower dead center−dwell−eject
2. Bracing (synchronously with the upper unit 8) beyond the lower dead center−ejection of the material cut out as a “side effect”
3. Plain ejector function

In order to synchronize the movement of the holding ram 25 to the movement of ram 21 at the moment when machining actually starts with as little delay as possible, the press 1 according to the invention has bridging means 50 (see FIGS. 2A-2D) for bridging the response time to ensure acceleration of the additional actuator 27 in particular (see FIGS. 2A-2D), where the bridging means 50 are preferably provided directly in the hold-down device 20 and/or in the holding device 24.

The holding ram 25 may be accelerated solely by the ram 21 by the bridging means 50, i.e. bypassing the additional actuator 27. Also, in the event of a malfunction, enough time may be made available by the bridging means 50 that the actual overload protection unit of the press 1 can be deployed and be effective.

FIGS. 2A through 2D illustrate the bridging means 50 in greater detail in conjunction with the holding device 24, where the reference numerals have been distributed among the individual FIGS. 2A through 2D for the sake of simplicity.

The bridging means 50 is between the holding ram 25 and a connecting rod 51 of the actuator 27 here designed as a pneumatic nitrogen spring 52 that has a cylinder 54 and a piston 55 guided therein. The cylinder 54 and the piston 55 form a pressure chamber 57 filled with a body 56 of nitrogen (N₂) as the pressure medium.

A height 58 of the pressure chamber 57 between a top face of a piston head 60 and a bottom face 61 of the cylinder 54 is such that the holding ram 25 of the holding device 24 can be displaced downward by about 25 mm in the direction z regardless of the actuator 27. In this way, there is a large enough time window available for accelerating the actuator 27 accordingly before the holding ram 25 is moved by it. On the other hand, the holding ram 25 may be shifted downward by at least 25 mm in the direction z in an emergency without having to move the piston 55 and/or the actuator 27. This gains time until the actual overload protection unit can be activated.

In this respect, the pneumatic spring 52 provides a reaction stroke 59 of 25 mm on the whole. The magnitude of this reaction stroke 59 is determined by the height 58 of the pressure chamber 57 between an end face of a head 60 of the piston 55 and an inner end face 61 of the cylinder 54. The pressure chamber 57 and in particular the piston head 60 are in a cavity 62 formed by the cylinder 54.

The cylinder 54 here is displaceably guided in a bushing 63 of the lower die subassembly 13 independently of the piston 55. Thus the entire cylinder 54 may be moved downward toward the actuator 27 in the direction z during a machining operation. The piston 55 here does not need also to be displaced with the cylinder 54. Nevertheless the cylinder 54 is displaceable by the piston 55 with respect to the lower die subassembly 13 because the piston head 60 can interact with a shoulder 64 of the cylinder 54 in such a way that the cylinder 54 is engaged and entrained by the piston 55 when it is moved downward toward the base 14 in the direction z.

The ram 25 is carried on the cylinder 54 at a spacing from the cylinder end wall 61 by web elements 65 that extend through holes 66 in a top side plate 67 of the lower die subassembly 13. Because of the more complex movement sequences of the holding device 24 in particular, it is advisable to divide these movement sequences into two phases.

The first phase of the bracing may be referred to as the “die cushion phase.” The second phase of ejection begins after the upper die subassembly 8 has passed through lower dead center. A sufficiently high requirement to be made of the holding device 24 would be a bracing force of 300 kN (=30 t), a stroke of 25 mm and synchronization with the upper die subassembly 8 at a press lift count of at most 60 strokes per minute (based on the standard kinematics without modification of the ram curve).

According to the diagrams in FIGS. 2A to 2D, four positions are illustrated on the example of the holding device 24 during various operating states that proceed properly. The same mechanical factors preferably also apply to the hold-down device 20.

In the starting position shown in FIG. 2A, the holding ram 25 is in contact with the bottom face of the sheet metal workpiece 18. Its actuator 27 is set so that the cylinder 54 is moved by the piston 55 in the direction z toward the upper die subassembly 8. The gas body 56 in the pressure chamber 57 is compressed, so that the piston 55 is shifted in the cavity 62 by 5 mm toward the cylinder end wall 61 and the volume of the pressure chamber 57 is reduced accordingly. The upper edge of the cylinder 54—and thus indirectly also the holding ram 25 fixedly connected to the cylinder 54—is in contact with a stop 68. The nitrogen spring 52, which at the same time forms a mechanical overload protection, is thus retracted here by 5 mm.

If the upper die subassembly 8 now moves downward toward the lower die subassembly 13, then the piston 55 moves back downward by this 5 mm until the piston end face 60 reaches the shoulder 64 (see FIG. 2B). However, as this happens the holding ram 25 remains unchanged in its position assumed previously (see FIG. 2A) because the piston 55 has been able to move freely in the cavity 62 up to that point. The pressure of the pressure medium 56 in the pressure chamber 57 is so high that the holding ram 25 is moved immeasurably or by only a negligibly small amount with respect to the sheet-metal workpiece 18 despite the increase in the size of the pressure chamber 57. In this respect, the upper edge of the cylinder 54 is still in contact with the stop 68. The movements of the holding ram 25 and the upper die subassembly 8 thus run essentially asynchronously up to this point.

According to FIG. 2B, the die 9 of the upper die subassembly 8 has now reached the sheet-metal workpiece 18. Only at the start of the cutting operation is the holding ram 25 moved downward synchronously with the cutting punch 9, regardless of the additional actuator 27. In this context, the pneumatic spring 52 may function as a “die cushion.” Only after this 5 mm “no load stroke” can the holding ram 25 be moved downward directly by the additional actuator 27 (see FIGS. 2C and 2D).

According to the additional position in FIG. 2C, waste 17 is cut out of the sheet-metal workpiece 18, and the holding ram 25 is then shifted further downward by the actuator 27. This takes place because, among other things, the cylinder 54 is entrained by the piston 55.

According to the bottom end position in FIG. 2D, the holding ram 25 is in its lowest position, from which it is moved back in the direction z toward the upper die subassembly 8 by the actuator 27. The gas body 56 in the pressure chamber 57 is then compressed again according to the manner described above and the cycle begins again from the beginning.

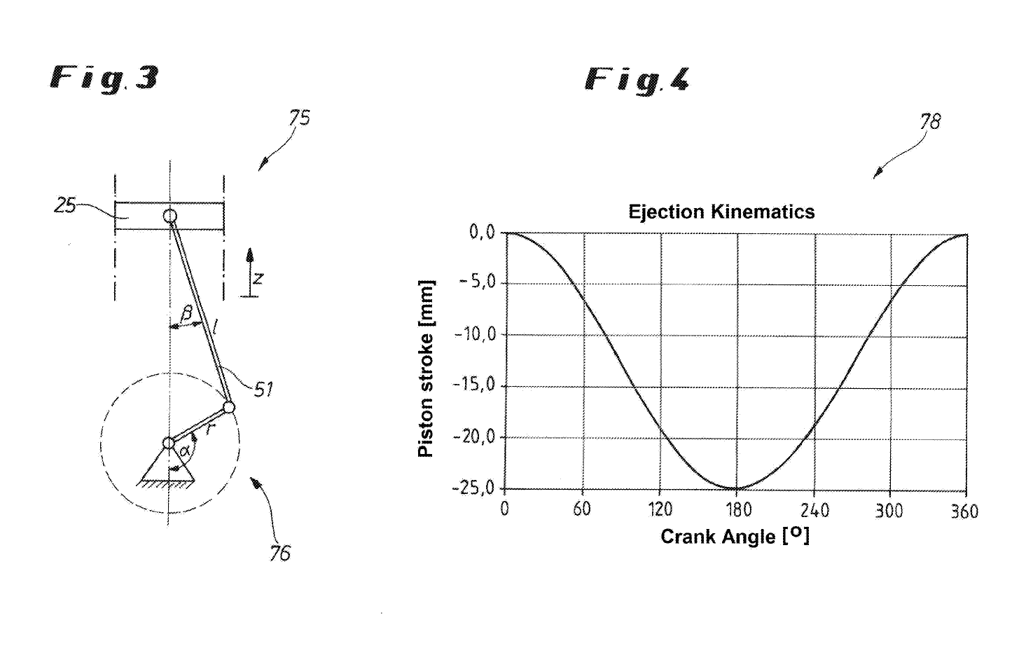

According to the diagram in FIG. 3, for example, the function of the actuators 23 and 25 are illustrated in simplified terms on the basis of a toggle-linkage actuator 75, where

r=radius of the crank 76 (eccentricity) (mm);

l=length of the connecting rod 51 (mm);

z=lift of the ram 25 (mm);

α=angle of rotation of the crank 76 (°) and

λ=ratio between the crank and connecting-rod length.

The following equation holds here:

r*sin α=l*sin β [3.1]

The following equation is obtained for the ram position z on the basis of the dimensions of the slider crank drive 75 and the angle of rotation α:

z=r−r*cos α+l−l*cos β [3.2]

With the help of the known equation

sin² β+cos² β=1 [3.3]

and a rearrangement of [3.1] according to sin β, cos β can be represented as follows:

$$cos β = \sqrt{1 - {( \frac{r}{l} )}^{2} * {sin}^{2} α} \qquad [ 3.4 ]$$

Inserting equation [3.4] into equation [3.2] yields the following for the ram stroke:

$$z = r ( 1 - cos α ) + l ( 1 - \sqrt{1 - {( \frac{r}{l} )}^{2} * {sin}^{2} α} ) \qquad [ 3.5 ]$$

With the abbreviation λ=r/l pusher rod ratio, it follows that:

z=r(1−cos α)+l(1−\sqrt{1−λ²*sin² α}) [3.6]

Calculation of the radial stroke according to equation [3.6] yields positive values for z. However, a negative value is more appropriate for the calculation of the ram position of the ejector. Therefore, the right side of equation [3.6] is multiplied by −1.

In the diagram according to FIG. 4, a diagram 78 of the kinematics with respect to ejection is shown for r=12.5 mm and 1=252.5 mm.

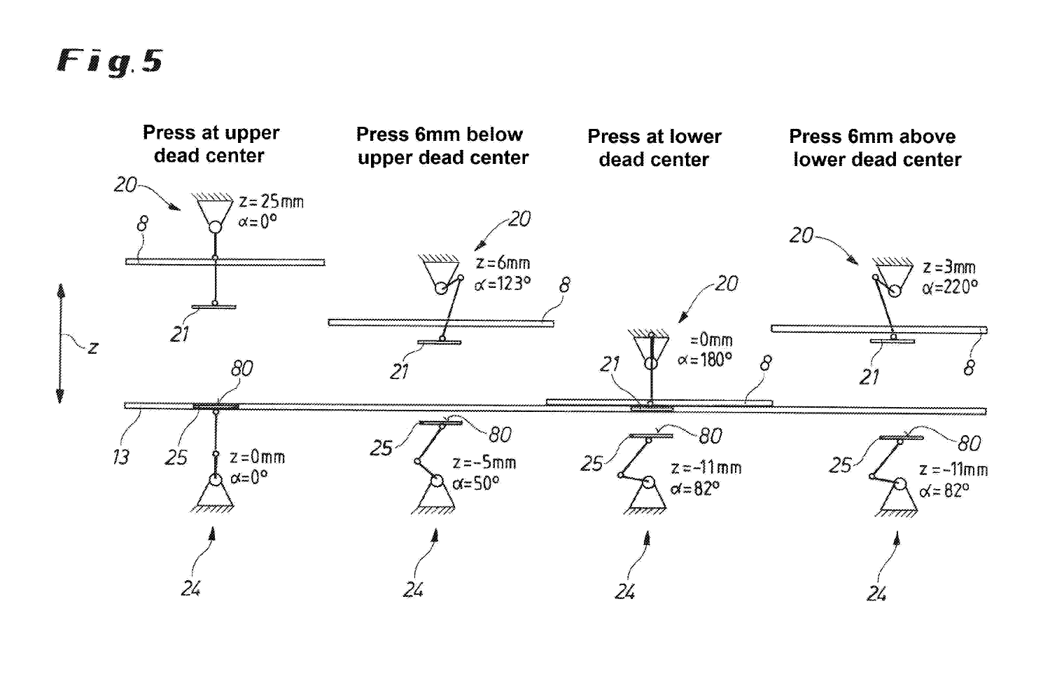

For the function sequence shown in FIG. 5 during a machining operation on the press 1, the assumption that the holding device 24 is in the lower die subassembly 13 and the hold-down device 20 is in the upper die subassembly 8 is applicable in particular. For the input of position values and for the calculation of the ejector curve, it is also assumed that the holding ram 25 is at α=0° in the extended position (at upper dead center). This means that the upper edge 80 of the holding ram 25 is flush with the lower die subassembly 13 and/or the die. If the holding device 24 is completely lowered (lower dead center), then it is at α=180°; s=−25 mm. For the determination of the hold-down curve, it is more appropriate to work with positive kinematics. In the stretched position the ram 21 is completely extracted and stands at α=0°; s=+25 mm. At a crank angle of α=180°, the ram 21 is flush with the hold-down device 20.

The speed of the respective ram is calculated with α=ω*t by the deviation of the stroke according to time.

$$v = \frac{d z}{d t} = \frac{d z}{d α} * \frac{d α}{d t} = ω * \frac{d z}{d α} \qquad [ 3.7 ]$$

With [3.6] it follows from this that

$$v = r * ω * ( sin α + \frac{λ}{2} * \frac{sin 2 α}{\sqrt{1 - {λ}^{2} * {sin}^{2} α}} ) \qquad [ 3.8 ]$$

As an approximation, the speed can be calculated as follows:

$${v}_{N} = r * ω * ( sin α + \frac{λ}{2} * sin 2 α ) \qquad [ 3.9 ]$$

The torque on the drive shaft at a predefined load is calculated approximately with

M≈F*r*sin α [3.10]

Equation [3.10] describes only the required torque exerted by the load on the drive. For the design of the drive, the acceleration torque must also be taken into account.

As already mentioned above, the function of the holding device 24 may be divided into two separate phases. The first phase is the “die cushion phase” in which the holding device 24 yields synchronously with the movement of the upper die subassembly 8 in a defined position and serves as a bracing device for the die 9 and/or the workpiece 18. The second phase is the “ejection phase.” The first phase is concluded when the upper die subassembly 8 reaches lower dead center. It is advantageously provided that the holding device 24 remains in the position reached by then until the defined starting angle (crank angle of the press 1) has been reached at the start of the ejection phase.

For the ejection movement, the direction of movement of the holding device 24 is reversed. The ejection phase is ended at the latest on reaching the upper dead center of the press 1. The movement sequence of the holding device 24 begins with the start of the press 1 at upper dead center. The position of the ram before upper dead center describes the defined position beyond which the holding device 24 must be synchronized with the upper die subassembly 8. At a press stroke count of 60 strokes per minute and an impact position of 10 mm, the upper die subassembly 8 requires about 0.4 seconds until the position has been reached. The holding device 24 must be moved to a position of −5 mm at this time.

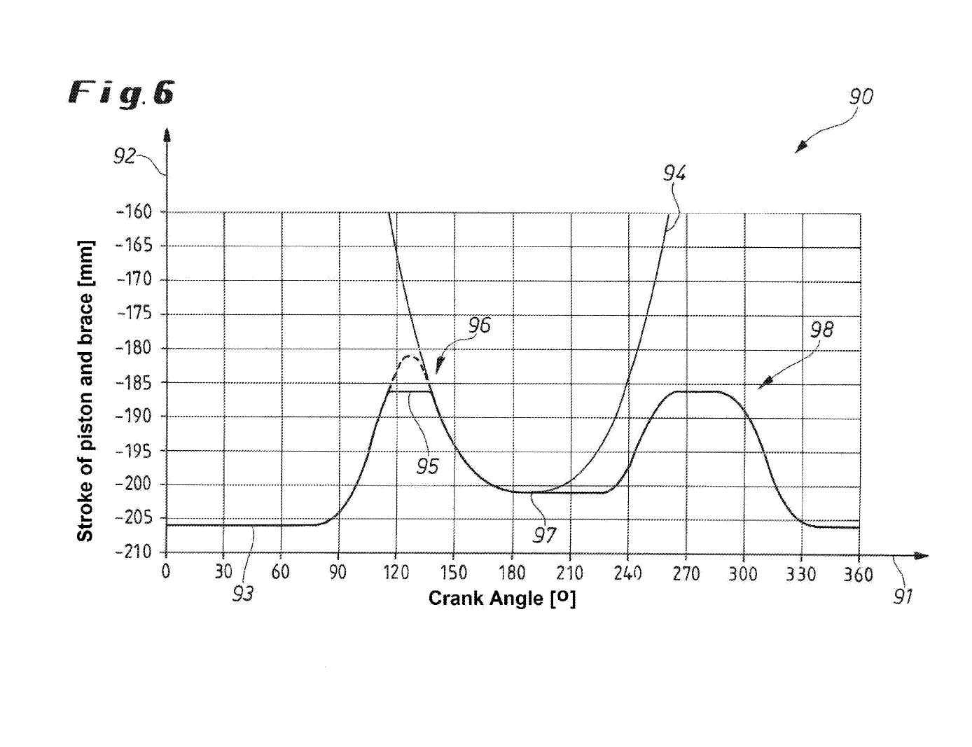

In the diagram according to FIG. 6, function characteristic lines, for example, are shown in a coordinate system 90 on the example of the holding ram 25 and/or the holding ram 25 in this regard in conjunction with the ram 21 and/or the cutting punches 9. The crank angle of the respective actuator 23 and/or 27 is plotted on the abscissa 91 of the coordinate system 90. The spacing 93 of the holding ram 25, on the one hand, and the spacing 94 of the cutting punch 9, on the other hand, are plotted on the ordinate 92. It can be seen well here that the holding ram 25 is shifted into position 95 by the additional actuators 27 in order to then raise it by an additional 5 mm by the pneumatic spring 52 of the bridging means 50 and to thereby press it against the lower side of the workpiece 18 (cf. FIG. 2A). If the cutting punch 9 is then moved toward the workpiece 18 from above (cf. FIG. 2B), then the holding ram 25 is already synchronized with the speed of the cutting punch 9 at the start 96 of the cutting operation, by passing the actual additional actuator 27, until A point in time 97 at which the cutting punch 9 moves upward again. Next the holding ram 25 can pass through a freely programmable ejector movement 98 so that the holding ram 25 here is driven by the additional actuator 27.

The illustrated embodiment described above involves only a first design of the inventive press 1. In this respect, the design of the invention is not limited to this illustrated embodiment.

We claim:

1. A press comprising:
a frame;
an upper die vertically shiftable on the frame;
drive means for vertically shifting the upper die on the frame;
an upper holding ram vertically shiftable in the upper die;
an upper actuator connected between the upper holding ram and the upper die and operable to move the upper ram vertically relative to the upper die;
a lower die on the frame below the upper die;
a lower holding ram vertically shiftable in the lower die;
a lower actuator connected between the lower holding ram and the lower die and operable to move the lower ram vertically relative to the lower die; and
bridging means connected between one of the actuators and the respective die for bridging an acceleration phase of the respective actuator in which the respective actuator can be accelerated to the speed of the respective ram.

2. The press defined in claim 1, wherein the bridging means (is a pneumatic spring.

3. The press defined in claim 2, wherein the pneumatic spring is a nitrogen spring.

4. The press defined in claim 1, wherein the bridging means has a reaction stroke of more than 10 mm.

5. The press defined in claim 4, wherein the reaction stroke is formed by a pressure chamber filled with a pressure medium and between a lower face of a piston of the respective actuator and an end wall of a cylinder of the respective actuator.

6. The press defined in claim 1, wherein the bridging means is between the respective ram and the respective actuator.

7. The press defined in claim 6, wherein the bridging means has a cylinder and a piston therein, the respective ram being on the cylinder.

8. The press defined in claim 7, wherein the respective ram is spaced from an end wall of a cylinder of the respective actuator by web elements.

9. The press defined in claim 1, wherein the bridging means has a cylinder and a piston guided therein, the cylinder being in the lower die so that it is displaceable toward the upper die.

10. The press defined in claim 1 wherein the bridging means has a cylinder and a piston guided therein, the cylinder being displaceable in a guide bushing of the respective die.

11. The press defined in claim 1, wherein the bridging means has a cylinder and a piston guided therein, the cylinder being displaceable by the piston with respect to the respective die.

12. The press defined in claim 1, wherein the bridging means has a cylinder and a piston guided therein, the piston being carried on a connecting rod part of an eccentric drive of the respective actuator.
